(19) United States
(12) Patent Application Publication
(10) Pub. No.: US 2009/0019493 A1
(43) Pub. Date: Jan. 15, 2009

(54) CACHE AFFILIATION IN IPTV EPG SERVER CLUSTERING

(75) Inventors: Qiang Li, Saratoga, CA (US); Chen Ma, Fremont, CA (US); Huiyou Zhu, Fremont, CA (US); Naxin Wang, Cupertino, CA (US)

Correspondence Address: UTSTARCOM, INC.;c/o Laura Weiss, Paralegal, 3800 Golf Road, Suite 220, Rolling Meadows, IL, 60008, US

(73) Assignee: UTSTARCOM, INC., Alameda, CA (US)

(21) Appl. No.: 11/776,947

(22) Filed: Jul. 12, 2007

(51) Int. Cl. H04N 5/445

(52) U.S. Cl. 725/49

(57) ABSTRACT

An EPG service architecture incorporates multiple EPG servers connected in a cluster. An active dispatcher is associated with at least one EPG server and multiple standby dispatchers are associated with the cluster. A plurality of STBs interfaced with the EPG server cluster issue requests for EPG service for which the active dispatcher employs an affiliation table as a portion of the cache for redirecting each request to a specific one of the EPG servers affiliated with the STB issuing the request. The active dispatcher multicasts the affiliation table to the multiple standby dispatchers for synchronization.

### REFERENCE TO RELATED APPLICATIONS

This application is copending with application Ser. No. 11/776,766 attorney docket no. U001 100301 entitled HYBRID EPG SERVER WITH SERVICE DISPATCHER TO BUILD A DISPATCHER REDUNDANCY CHAIN IN CLUSTERED IPTV EPG SERVICE fried substantially concurrently herewith and having a common assignee with the present application, the disclosure of which is incorporated herein by reference as though fully set forth.

### BACKGROUND OF THE INVENTION

1. Field of the Invention

This invention relates generally to the field of Electronic Program Guide (EPG) servers for Internet Protocol Television (IPTV) service and more particularly to an architecture and method for cache affiliation for clustered IPTV EPG servers.

2. Related Art

The IPTV EPG server is a gateway between users and IPTV system. IPTV allows tailoring to each user's individual viewing habits. To allow such tailoring the user's profile must be stored for use by EPG server. When a user sends request to the EPG server, the IPTV system will load requesting user's profile from the server and return results based on the information inside the profile. This scheme works ideally if there is only one EPG server online and all user profiles are stored in this single server.

However, in current systems, due to the heavy traffic, EPG servers are designed to be clustered, creating a challenge for user profile access. In a common cluster, a user's request can be directed to any machine inside a server pool. The machine might or might, not have the necessary user profile stored on it.

The user's current viewing pattern is highly correlated, to his past viewing behavior. In prior art systems, the IPTV EPG saves the user's past viewing behavior to a cache that is local to one EPG server. In other words, the cache that contains user A's viewing behavior is saved on EPG server B and is only accessible from server B. Therefore, A's user profile is persistent through the cache. This is described in art as user A is affiliated with EPG server B.

Each EPG server has its own cache. This cache contains non-vital data that must be accessed frequently. A tradition solution to the problem of requiring an affiliated user and server is to establish a central database that keeps track of a matching between user and destination EPG server. This solution is prone to its own weaknesses in that a single point failure is present with the central database and expensive extra hardware costs in order to maintain the database are present. In addition, the frequent data access puts heavy burden cm a centralized database. Nevertheless, the pressure can be ameliorated by taking advantage of a pool of EPG servers.

It is therefore desirable to configure EPG servers within a clustered EPG service platform to accommodate user profile caching while simplifying user redirection to an affiliated server.

### SUMMARY OF THE INVENTION

The present invention provides an EPG service architecture which incorporates multiple EPG servers connected in a cluster without losing user's profile. An active dispatcher is physically deployed on an EPG server and multiple standby dispatchers are associated with the cluster. A plurality of STBs interfaced with the EPG server cluster issue requests for EPG service for which the active dispatcher employs an affiliation table for redirecting each request to a specific one of the EPG servers affiliated with the STB issuing the request.

In an exemplary embodiment, the active dispatcher further multicasts the affiliation table to the multiple standby dispatchers for synchronization.

### BRIEF DESCRIPTION OF THE DRAWINGS

These and other features and advantages of the present invention will be better understood by reference to the following detailed description when considered in connection with the accompanying drawings wherein:

FIG. 1 is an example affiliation table for use in the exemplary embodiment of the invention;

FIG. 2 is a block diagram of the EPG server cluster elements employed by the exemplary embodiment; and,

FIG. 3 is a flow diagram of the active dispatcher operation for redirection of STP requests and affiliation table distribution.

### DETAILED DESCRIPTION OF THE INVENTION

In the IPTV EPG, a user's current behavior is correlated to his past, behavior. The user interface to the EPG can be viewed as a hierarchical tree so that the current node can only be reached by walking down a specific branch in tire tree. In order to remember the current state of the user, past viewing behavior must be saved. To accomplish the necessary correlation, each user's profile is saved in a cache.

The cache only contains the logic from the presentation layer or user interface layer. The business logic associated with the user is not cached locally in the EPG server, but in a centralized user profile server. The presentation, layer defines what the user can see from IPTV and is considered non-critical. In the worst case, the user only has to re-walk the user interface tree to reach the current state. The business layer contains data that is essential to the user, such as account information, billing data, and other similar information. Therefore, it must be stored in a secure location, which is not part of the cluster.

Since the cache is only local to the server, the user profile data is also only local to each EPG server. This user profile data is not shared among the pool of EPG servers in the cluster. To be specific, user A's profile is and will always be stored in EPG server, B. EPG server C, even in the same pool as EPG server B, does not have the access to user A's profile.

In an exemplary EPG server cluster such as that disclosed in co-pending patent application Ser. No. ______, attorney docket no, U001 100301 entitled HYBRID EPG SERVER WITH SERVICE DISPATCHER TO BUILD A DISPATCHER REDUNDANCY CHAIN IN CLUSTERED IPTV EPG SERVICE filed substantially concurrently herewith and having a common assignee with the present application, the disclosure of which is incorporated herein by reference as though fully set forth, there is one EPG dispatcher deployed along with each EPG server in the cluster. The EPG dispatcher is a stand-alone process. Nevertheless, there could be multiple EPG dispatcher processes which are running simultaneously. In the exemplary embodiment, there is only one EPG dispatcher actively handling the user requests. All other EPG dispatchers are alive (send and receive heartbeat messages), but placed in standby and not handling any requests from the users.

Within each dispatcher there is a table having a primary role to build a one-on-one matching between a user and a destination EPG server. This table stores vital user and destination EPG server information. A simple structure of the table format is depicted in FIG. 1 demonstrating in affiliation table 10 the presence of a source IP address 12, a time 14 and a destination IP address 16. The source IP address corresponds to the IP address of a user Set Top Box (STB) while the destination address corresponds to the EPG server to which the most recent request by that STB was redirected. The table affiliates a user to an EPG server with each table line element 18.

Since this matching is permanent, this affiliation table must be able to sustain failure. For the exemplary embodiment disclosed in copending application docket no. U001 100301, the dispatcher is a redundant resource and is present in each EPG server. If one dispatcher is offline, a standby dispatcher with the highest priority will immediately resume the duties of the primary or active dispatcher. With the characteristic of the clustering structure, any dispatcher potentially can become a primary dispatcher.

The STB only needs to know one IP address in order to take advantage of clustering even though the user profile must be handled exclusively by one single EPG server. Traditionally with clustered EPG server architectures, if a client STB only knows one IP address, die requests from this client STB can be directed to any one of the sewers in the cluster. This approach is not desirable for maintaining the optimum EPG services to a user in IPTV EPG cluster solutions because all user requests from one STB must always be directed to one EPG server for access to the profile. One prior art method ensures only one server handles all requests from one client, but the client must store two IP addresses, the dispatcher upfront and the real server.

For the embodiment of the present invention, the initial request from a user triggers the active dispatcher to establish the connection between the user STB and one EPG server, making the subsequent requests from this user STB a reference to look up in the affiliation table. Every standby dispatcher that is not currently handling requests sends heartbeat message to the active dispatcher, the one currently handling all user requests. The active dispatcher has the latest and most up to date affiliation table information regarding the user and EPG server matching. The difference in affiliation table content is synchronized to every standby dispatcher in response to the heartbeat signal. This ensures that every dispatcher always has the most up-to-date data.

When an EPG server fails, all cache that is local to that server is lost. The subsequent requests to that server will be rerouted to other EPG servers based on their workload. Addition and subtraction of EPG servers in the cache to the pool due to respective initialization or failure of a server in the cluster is also handled by the active dispatcher. When an EPG server is removed from the cluster, the profiles affiliated with this EPG server are also lost. If a user who is affiliated with this removed server sends an additional request, his request will be redirected to another server inside the cluster. The server will treat the user as a first-time user and recreate the user profile. Addition works in a similar fashion where the new server will be considered with the lightest workload and users selected by the active dispatcher will be assigned to the new server. Consequently, no user profile cache will be present on the new server for the transferred users. The active dispatcher can flush certain portion of its table, for example, based on age flushing the oldest table contents by time stamp. The user whose affiliation is erased is treated as anew user and will be directed toward the EPG server with the lightest workload upon the next request, from that user.

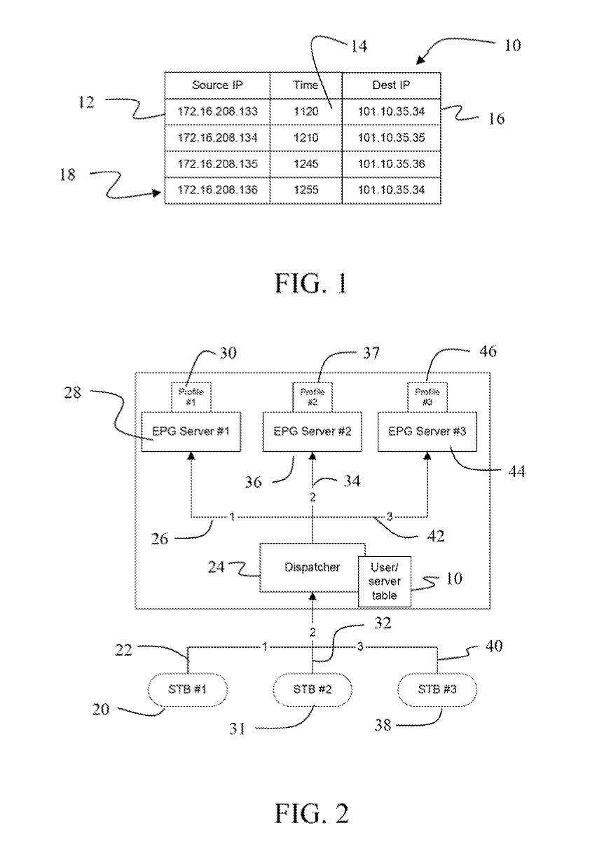

In FIG. 2, a general block diagram and workflow of a session based EPG clustering is presented. When STB #1 20 first sends an initial request 22, the active dispatcher 24 logs user's IP address in the affiliation table. Then the dispatcher determines the workload of EPG servers in the cluster and directs this request 26 to EPG server #1 28. In affiliation table 10, the dispatcher associates STB #1 with EPG server #1. As long as the request is from a STB that has not been logged in the table, a new entry is created. The EPG server to which the request was redirected then maintains a profile 30 for STB #1.

When STB #1 sends another request, the active dispatcher refers to the affiliation table and identifies STB #1 as an existing user. In turn, it routes the request to the destination IP address that has been recorded in the initial request. By doing so, requests from STB #1 always go to the same server. Therefore, the user profile of STB #1 is updated by the EGP server #1 for each redirected request and can always be retrieved for later user use or customization in the EPG operations of the server.

Similarly, for an initial, request 32 from STB #2 31, the active dispatcher togs user's IP address in the affiliation table. Then the dispatcher determines the workload of EPG servers in the cluster and directs this request 34 to EPG server #2 36. In the affiliation table, the dispatcher associates STB #2 with EPG server #2, EPG server #2 creates and maintains a profile 37 for STB #2. For an initial request 40 from STB #3 38, the active dispatcher logs the user's IP address in the affiliation table. Then the dispatcher determines the workload of EPG servers in the cluster and directs this request 42 to EPG server #3 44. EPG server #3 creates and maintains profile 46 for STB #3. In the table, the dispatcher associates STB #3 with EPG server #3. The orientation of the servers and STBs In FIG. 2 is purely for demonstrative purposes and has not actual relation to requirements of the architecture. However, the ability of the present invention to create and maintain a one-to-one relationship between a STB and the server storing die EPG data for that STB is demonstrated. The STB user is able to access their own profile in the EPG clustering without having a centralized database. Further, failure of the active dispatcher does not result in a loss of connectivity for the STB with the server storing the EPG profile for that STB by maintaining the affiliation list on the standby dispatchers, as will be described in greater detail subsequently.

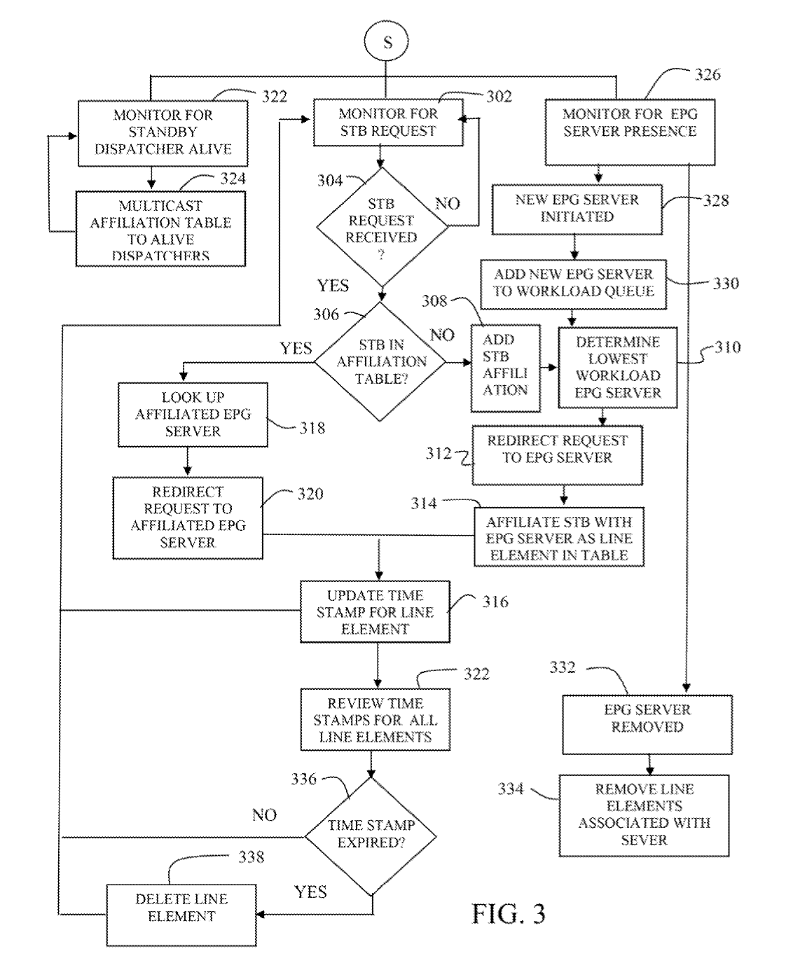

FIG. 3 provides a detailed flow chart for the operation of the active dispatcher. The dispatcher monitors for incoming STB requests 302. When a request is received 304, a comparison is made to the affiliation table 306 and if the IP address of the requesting STB is not present, the table is updated with an incoming IP address for the requesting STB 308. The dispatcher evaluates the workload of the available EPG servers in the cluster 310 and the request is then redirected to the EPG server with the lowest work load 312 and the IP address for that server is added to the table as the affiliated destination IP address 314 and time stamped 316. If the IP address of the requesting STB is present in the affiliation table the dispatcher looks up the affiliated EPG server 318 redirects the request to the affiliated destination IP address 320 and updates the timestamp in the affiliation table 316.

The active dispatcher is also monitoring the heartbeat for other standby dispatchers present in the cluster 322 and periodically provides an update to synchronize the affiliation table to standby dispatchers which are alive through a multicast 324 directed to all dispatchers which have initialized. If the standby dispatchers are taken off line and their heartbeat is not present, they are deleted from the multicast. Similarly newly initialized dispatchers are added to the multicast based on receipt of their heartbeat. Furthermore, the newly initialized dispatchers will receive the complete affiliation table from the active dispatcher. The synchronization is done in an incremental fashion wherein only the difference in the current affiliation table from the prior multicast table is sent, to other dispatchers. For example, if a multicast transmission, n, brings all standby affiliation tables up-to-date and there is only one new entry being logged in the active affiliation table after multicast transmission n, only this new entry will be multicasted to the standby affiliation tables in the next multicast transmission, n+1.

The dispatcher monitors for presence of servers in the cluster 326. Initialization of a new server 328 results in the addition of an available destination IP for requests 330 that will be selected for redirection of STB requests based on overall comparative workload. Similarly, the dispatcher monitors for failure or removal from service of an EPG server in the cluster and upon failure removes that destination IP address from the available list 332 and removes all associated entries in the affiliation table associated with that destination IP address 334.

To reduce the storage requirements, the active dispatcher reviews the affiliation table for expired time stamps 336 and if a time stamp has exceeded a predetermined expiration period, deletes line elements 338 which have expired. User profiles for expired time stamps will be lost however, setting of the expiration period will minimize any inconvenience to users since viewing sessions for which the profile was generated have ceased.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. An EPG service architecture comprising:
a plurality of EPG servers connected in a cluster;
an active dispatcher associated with at least one EPG server and a plurality of standby dispatchers associated with the cluster;
a plurality of STBs interfaced with the EPG server cluster and issuing requests for EPG service;
said active dispatcher having an affiliation table as a portion of the cache for redirecting each request to a specific one of the EPG servers affiliated with the STB Issuing the request.

2. The EPG service architecture of claim 1 wherein the active dispatcher further multicasts the affiliation table to the plurality of standby dispatchers for synchronization.

3. The EPG service architecture of claim 1 wherein the active dispatcher incorporates means for adding STBs to the affiliation table as a source IP address.

4. The EPG service architecture of claim 3 wherein the active dispatcher further incorporates means for adding EPG servers to the affiliation table as a destination IP address associated with a source IP address as a line element.

5. The EPG service architecture of claim 4 wherein the affiliation table includes a time stamp in the line element for a most recent redirected request from each affiliated STB and EPG server.

6. The EPG service architecture of claim 5 wherein the active dispatcher can select affiliation table line elements for deletion based on time stamp age.

7. The EPG service architecture of claim 2 wherein the multicast is responsive to an alive signal from the standby dispatchers.

8. A method for EPG service control comprising the steps of:
providing a plurality of EPG servers connected in a cluster
providing a plurality of dispatchers associated with the cluster, one of said dispatchers being active and the remaining dispatchers being in standby mode;
incorporating an affiliation table in a cache of the active dispatcher;
populating the affiliation table by the active dispatcher entering a source IP address for each STB entering a request to the cluster;
matching each source IP address to a destination IP address upon redirection of the request by the active dispatcher to a specific EPG server in the cluster;
time stamping the affiliated source and destination IP addresses for the most recent request redirected from the source IP address to the destination IP address by the active dispatcher; and
multicasting the affiliation table to the standby dispatchers.

9. The method of claim 8 further comprising the step of:
deleting line elements having a time stamp older than a predetermined period.

10. The method of claim 8 wherein the step of matching further comprises the steps of:
monitoring for EPG server presence;
adding newly initialized EPG servers to a workload assessment queue; and
selecting the specific EPG server for matching based on workload.

11. The method of claim 10 further comprising the steps of:
detecting removal of an EPG server from service;
removing line elements from the affiliation table associated with the removed server.

12. A method for EPG service control for establishing a specific relationship between a STB and a selected EPG server comprising the steps of:
providing a plurality of EPG servers connected in a cluster
providing a plurality of dispatchers associated with the cluster, one of said dispatchers being active and the remaining dispatchers being in standby mode;
incorporating an affiliation table in a cache of the active dispatcher;
populating the affiliation table by the active dispatcher entering a source IP address for each STB entering a request to the cluster;
matching each source IP address to a destination IP address for redirection of a request from a STB by the active dispatcher to a specific EPG server in the cluster affiliated with that STB through the affiliation table, the specific EPG server maintaining the EPG profile for that STB;
time stamping the affiliated source and destination IP addresses for the most recent request redirected from the source IP address to the destination IP address by the active dispatcher; and
multicasting the affiliation table to the standby dispatchers.
